(19) United States
(12) Patent Application Publication
(10) Pub. No.: US 2006/0015369 A1
(43) Pub. Date: Jan. 19, 2006

(54) Healthcare provider recommendation system

(76) Inventors: Sonja C. Bachus, Grass Valley, CA (US); Michael J. Abreu, Penn Valley, CA (US); Jeff A. Bachus, Grass Valley, CA (US); Karen D. Wallace, Grass Valley, CA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/181,158

(22) Filed: Jul. 13, 2005

Related U.S. Application Data
(60) Provisional application No. 60/588,846, filed on Jul. 15, 2004.

(51) Int. Cl. G06Q 10/00

(52) U.S. Cl. 705/2; 707/3

(57) ABSTRACT

An online database of patient-to-patient healthcare provider recommendations is provided. This database may provide a resource for choosing a physician, and a community of support for those facing medical challenges. Patients who have had a positive experience with a physician can register this physician online, and subsequent patients can search for a physician by a variety of categories, such as, e.g., location, specialty, or physician name. Registrants may have the ability to recommend more than one physician if they so choose. All registrations may be verified by the online service for current license status, correct contact information, and for positive recommendations. This database may be provided and maintained by a central server and accessed by users over the world wide web using a conventional browser application.

### CROSS-REFERENCE TO RELATED APPLICATIONS

This application claims the benefit of U.S. Provisional Application No. 60/588,846, filed on Jul. 15, 2004, entitled “Healthcare Provider Recommendation System,” the disclosure of which is incorporated by reference herein in its entirety.

### BACKGROUND

Patients typically desire a breadth of resources in making healthcare decisions. They should have access to multiple sources of information in order to choose the right physician for themselves and their families. An important resource in choosing a physician is recommendations from other patients, but this resource is difficult to utilize when a patient needs a specialist, has recently moved, or wants to find out more about a particular physician.

In the past, a family having a child with special medical needs may go through an exhaustive search to find the right physician. Unfortunately, there is no way for people to easily share their information about health care providers with others searching for similar health care services.

In 2000, a report from the Midwest Business Group on Health entitled, “How We Choose Doctors: What Is and What Could Be,” stated that almost 50 million households in the United States changed, added, or selected a physician within the previous two years. The report described that when selecting a physician, people tend to rely on the opinions of friends or relatives or on recommendations from other physicians or nurses. In addition, few reliable sources collect information on individual physician practices, and fewer still report their information to the public.

Accordingly, it would be desirable to provide a system that would allow healthcare consumers to search for and retrieve recommendations regarding healthcare providers submitted by other healthcare consumers.

### SUMMARY OF THE INVENTION

In accordance with embodiments of the present invention, a method for providing information regarding healthcare providers over a communications network is provided, comprising: receiving via the communications network a plurality of healthcare provider recommendations; storing a plurality of healthcare provider entries, each of the healthcare provider entries being associated with at least one healthcare provider recommendation; receiving a query for a healthcare provider via the communications network, said query comprising a query criteria; and providing a query response including one or more healthcare providers satisfying the query criteria, said query response including only healthcare providers associated with at least one healthcare provider recommendation.

In accordance with embodiments of the present invention, method for providing information regarding healthcare providers over a communications network is provided, comprising: receiving via the communications network a plurality of healthcare provider recommendations, wherein for each healthcare provider recommendation received, receiving provider practice information; storing a plurality of healthcare provider entries, each of the healthcare provider entries being associated with at least one healthcare provider recommendation; and reviewing the provider practice information for each healthcare provider recommendation.

### DESCRIPTION OF THE DRAWINGS

FIG. 1 shows an exemplary healthcare provider recommendation system, in with embodiments of the present invention.

FIG. 2 is a flowchart illustrating a method for providing information regarding healthcare providers, in accordance with embodiments of the present invention.

FIG. 3 shows an exemplary Recommendation Entry screen, in accordance with embodiments of the present invention.

FIG. 4 shows an exemplary Location Search screen, in accordance with embodiments of the present invention.

FIG. 5 shows an exemplary Name Search screen, in accordance with embodiments of the present invention.

FIG. 6 shows an exemplary Condition/Specialty screen, in accordance with embodiments of the present invention.

FIG. 7 shows an exemplary search results screen, in accordance with embodiments of the present invention.

### DETAILED DESCRIPTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description which follows are presented in terms of procedures, steps, logic blocks, processing, and other symbolic representations of operations on data bits that can be performed on computer memory. Each step may be performed by hardware, software, firmware, or combinations thereof.

In accordance with embodiments of the present invention, an online database of patient-to-patient healthcare provider recommendations is provided. This database may provide a resource for choosing a physician, and a community of support for those facing medical challenges. Patients who have had a positive experience with a physician can register this physician online, and subsequent patients can search for a physician by a variety of categories, such as, e.g., location, specialty, or physician name. Registrants may have the ability to recommend more than one physician if they so choose. All registrations may be verified by the online service for current license status, correct contact information, and for positive recommendations. This database may be provided and maintained by a central server and accessed by users over the world wide web using a conventional browser application.

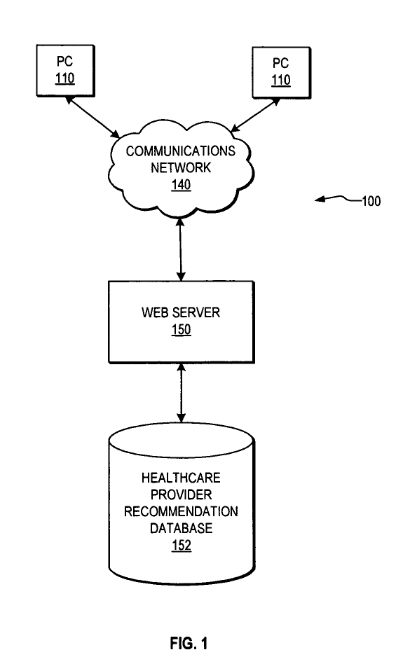

FIG. 1 shows an exemplary healthcare provider recommendation system 100, in accordance with embodiments of the present invention. A web server 150 is coupled to a communications network 140, such as, e.g., the Internet, and to a healthcare provider recommendation database 152. The web server 150 enables healthcare consumers to submit healthcare provider recommendations to be stored in the database 152, and to query the database 152 for previous healthcare provider recommendations submitted by other consumers. These healthcare consumers may utilize browser applications running on personal computers (PCs) 110 connected to the communications network 140.

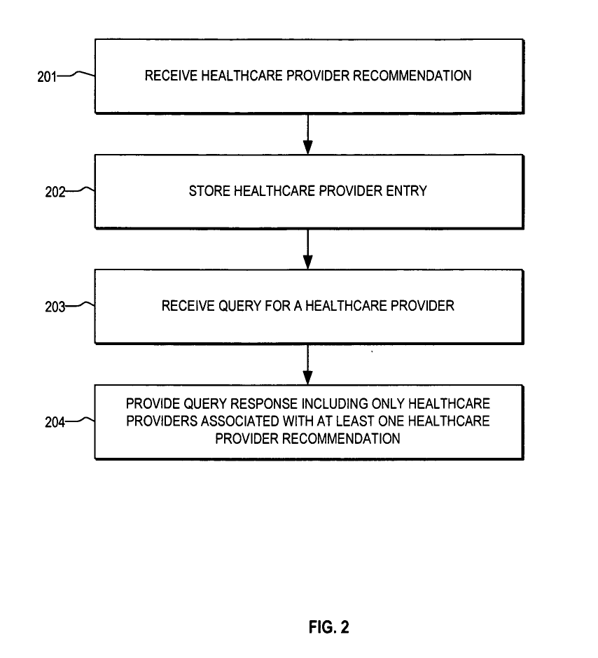

FIG. 2 is a flowchart illustrating a method for providing information regarding healthcare providers, in accordance with embodiments of the present invention. In step 201, a healthcare provider recommendation is received. In step 202, a healthcare provider entry is stored in the healthcare provider recommendation database 152. This healthcare provider entry is associated with at least one healthcare provider recommendation. In step 203, a query for an healthcare provider is received. In step 204, a query response is provided. This query response lists one or more healthcare providers satisfying the query criteria and includes only those healthcare providers that have previously received recommendations from other users.

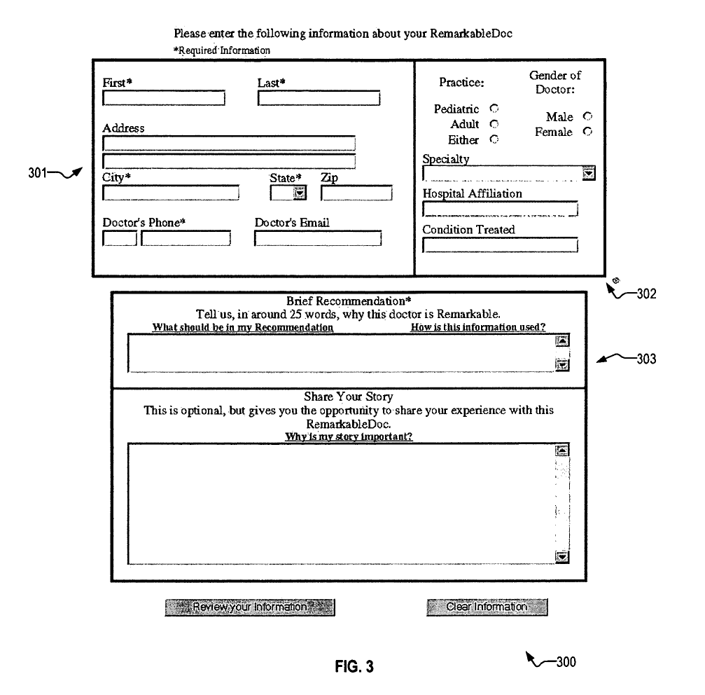

FIG. 3 shows an exemplary Recommendation Entry screen 300 that may be accessed by a user using a conventional browser application. This Recommendation Entry screen 300 may include various fields to be completed by the user to provide information regarding the healthcare provider. In the illustrated embodiment, the screen 300 includes a contact information section 301, a practice information section 302, and a narrative section 303. As can be seen in FIG. 3, the fields entered by the user may utilize various formats, such as, e.g., radio buttons, pull-down menus, and text strings.

The contact information section 301 may provide fields for entering contact information about the healthcare provider being recommended, including name, address, telephone number, and e-mail address.

The practice information section 302 may provide fields for entering various types of information regarding the healthcare provider's practice, such as whether it is a pediatric or adult practice, the healthcare provider's specialty, any hospital affiliation, and a description of the condition treated by that healthcare provider for the recommending user (who may be the healthcare provider's patient or a friend or relative of the patient).

The narrative section 303 may include a Brief Recommendation field to be used by the recommending user to describe the healthcare provider being recommended. A Share Your Story field may also be provided so that the user may include a narration of the patient's positive experience, and also may allow the registrant the option to leave their email address, in the event that they would be willing to communicate with others in further dialogue. This can enable the system to provide patients with a valuable support system when facing medical challenges. In this way, the system may create an online community for patients with common medical challenges.

After the user enters the requested information into the Recommendation Entry screen 300, the user is provided the opportunity to review and then submit the healthcare provider recommendation to be stored with previous recommendations in the database 152.

Subsequent users may then search the database 152 to obtain healthcare provider recommendations from other users. These querying users may also utilize a browser application to web pages generated by the web server 150.

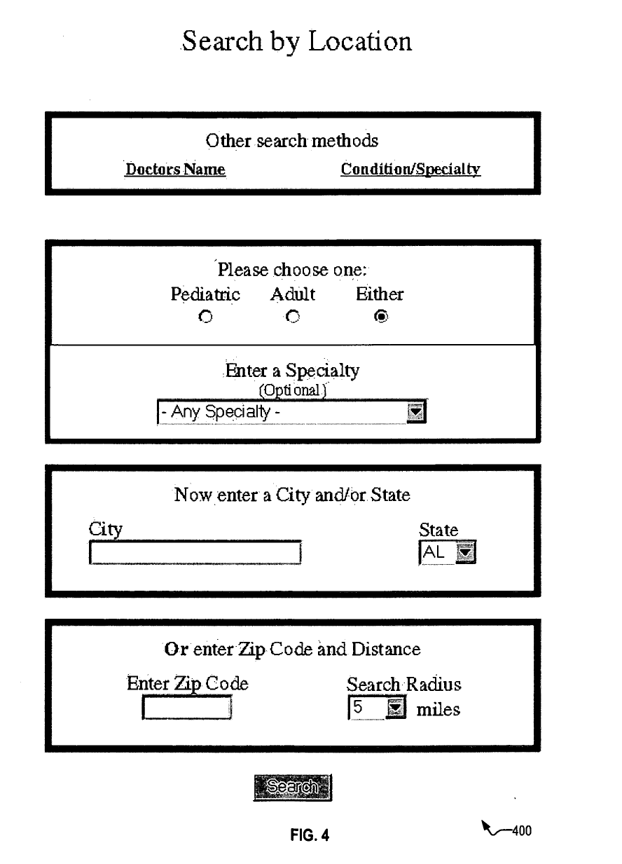

FIG. 4 shows an exemplary Location Search screen 400 that enables the user to search for a healthcare provider by various location criteria, such as city or proximity to a zip code. The screen 400 may further allow a user to narrow the location search for healthcare providers based on the practice information provided in the practice information section 302, shown in FIG. 3.

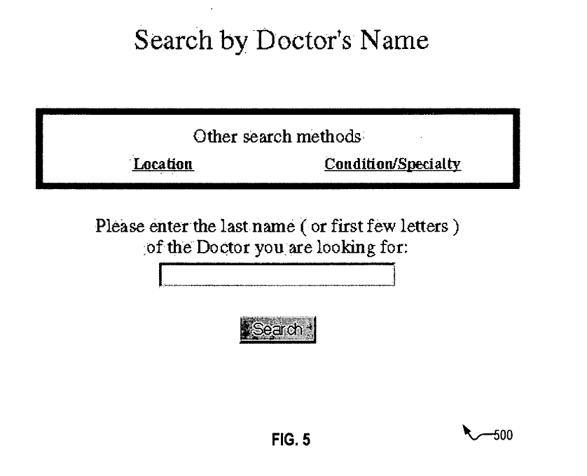

Alternative methods of querying for healthcare provider recommendations may also be provided. FIG. 5 shows an exemplary Name Search screen 500, which would allow users to query the database 152 for a particular physician's name to determine whether any recommendations for that physician have been posted.

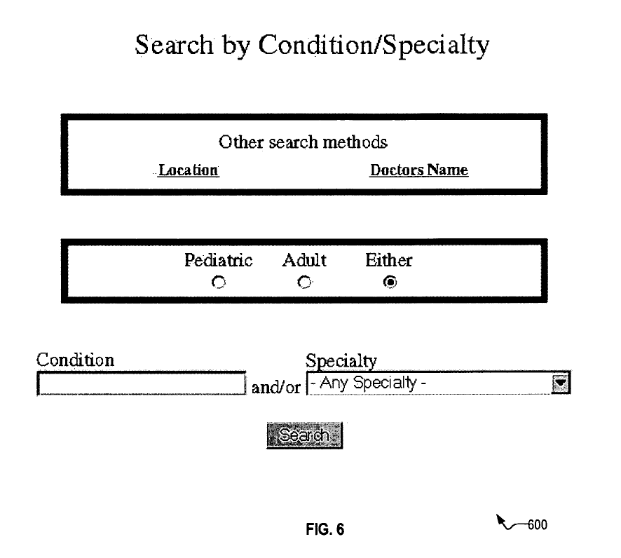

FIG. 6 shows an exemplary Condition/Specialty screen 600, which enables a user to query the database 152 based on whether the healthcare provider's practice is adult or pediatric, by medical condition, and/or by the physician's specialty.

The ability to search by medical condition can be particularly desirable for users who are seeking medical treatment for uncommon medical conditions. It can be particularly helpful to read healthcare provider recommendations from other users who are coping with the same condition. In many cases, only a small number of physicians specializing in a certain area have had experience in treating a particular condition. It may otherwise be difficult to locate these physicians.

For example, there are many physicians who specialize in orthopedic surgery. However, not all of these physicians have had extensive experience treating Proximal Femoral Focal Deficiency (PFFD), thus making it difficult to locate good healthcare services. In this situation, it would be helpful for a user to be able to search for the patient's particular condition (e.g., PFFD) when searching for healthcare provider recommendations. In other cases, the system may also enable users to search for keywords in the text entered in the Share Your Story field or other narrative fields. This can also help users connect with other users having similar experiences. Talking to others who have lived through a similar medical diagnosis can help patients feel more in control. Facing the illness with the support of others can help provide strength.

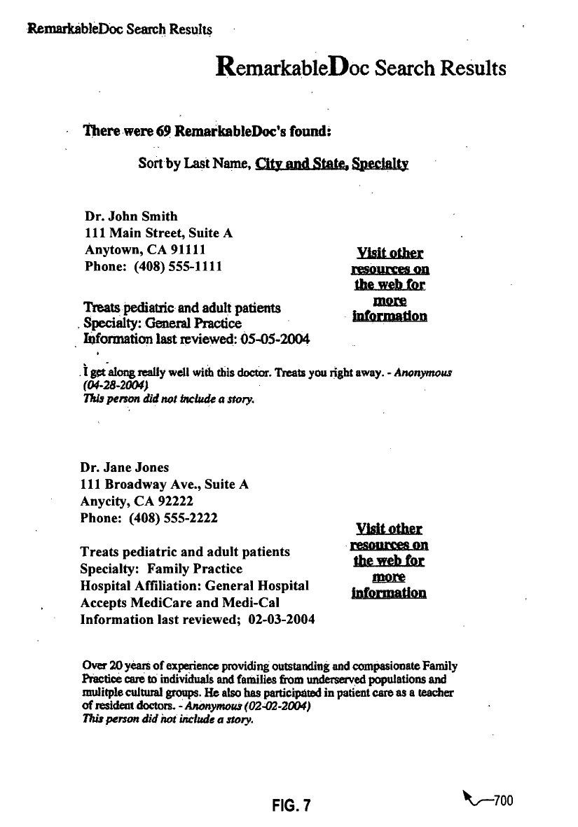

FIG. 7 shows an exemplary screen showing the results of a search. These results can be resorted according to various criteria. The information provided in these results may include some or all of the information entered by the recommending user in the Recommendation Entry screen 300.

In accordance with some embodiments, information regarding the recommended healthcare providers may be reviewed and confirmed to ensure the accuracy of the information. This review may occur prior to making those recommendations available for searching by other users and/or on a periodic basis. The review may cover one or more types of information, such as, e.g., the status of a recommended physician's medical license, the spelling of the healthcare provider's name, the contact information, specialty, type of treatment (adult, pediatric, or both), and hospital affiliation.

In accordance with some embodiments, it may be desirable to limit the system to providing only positive recommendations. Thus negative recommendations would not be included in the database 152. This may be desirable it if is believed that negative information may make medical choices more difficult. In addition, there are other sources providing information in this area.

In accordance with some embodiments, the database of healthcare provider recommendations may be limited to recommendations from users within a particular organization or company. This database would provide a resource for other employees who are choosing a physician. This system may be provided as a secure internal site, accessible only through the company's intranet, and may also provide a link to an external general public database for accessing positive healthcare provider recommendations from a broader group of patients. For example, all of the recommendations from patients across the country may be provided in the general public database.

With the ever-increasing importance of benefits in the marketplace, the healthcare provider recommendation system can provide companies with another valuable tool to add to their benefits package. Employees are likely to feel more secure about recommending their physicians through a company intranet site. Other employees searching for a physician are likely to have more trust in a recommendation from a fellow employee. With the recommendations from fellow employees, a user to the site would be assured that their company's insurance included the recommended physician.

Embodiments of the present invention may provide the following advantages. The system may provide a direct link between patients creating a forum for support and for recommending physicians to others in need. The system may be configured to include only patient recommendations. In some cases, no fees are required or solicited for inclusion in the database. The system may be easily accessible via the Internet, or may be limited to a smaller collection of users on a private intranet. The system may also be a comprehensive site for healthcare specialties; any healthcare provider can be recommended by a patient and viewed via the site.

This system can be an avenue for tremendous change. Previously, a search for a physician was limited by word of mouth from friends in the community or by professional referrals. Now, this system can create a community of support for all patients across a distributed geographic area.

In accordance with embodiments of the present invention, systems are provided for searching from a database populated solely with patient-recommended healthcare providers. This is in contrast with existing online systems, which enable patients to post feedback on specific physicians, but also provide physician listings for physicians who have not received any patient recommendations. There are several different sources of health care information available, including various programs providing free or fee-based information through the Internet. In addition, some insurance companies provide searchable databases to enable subscribers to search for physicians within those companies' coverage networks based on a variety of criteria, such as location or specialty. Furthermore, some of these online systems may list physicians based on their subscription to fee-based patient-referral services, or based on ratings by other healthcare providers.

By limiting the scope of the database to only those healthcare providers who have been recommended by patients, the ease of searching can be considerably improved by narrowing the scope of the search. In addition, the level of confidence and trust by healthcare consumers may be increased with the knowledge that all of the referrals are from other consumers, who may be in similar positions and have similar needs. Research supports the fact that consumers choose physicians based on other patients' recommendations.

While the invention has been described in terms of particular embodiments and illustrative figures, those of ordinary skill in the art will recognize that the invention is not limited to the embodiments or figures described. For example, the screens depicted in the figures and described above are merely exemplary. It will be understood that in other embodiments, the interface with the users may vary.

The program logic described indicates certain events occurring in a certain order. Those of ordinary skill in the art will recognize that the ordering of certain programming steps or program flow may be modified without affecting the overall operation performed by the preferred embodiment logic, and such modifications are in accordance with the various embodiments of the invention. Additionally, certain of the steps may be performed concurrently in a parallel process when possible, as well as performed sequentially as described above.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method for providing information regarding healthcare providers over a communications network, comprising:
receiving via the communications network a plurality of healthcare provider recommendations;
storing a plurality of healthcare provider entries, each of the healthcare provider entries being associated with at least one healthcare provider recommendation;
receiving a query for a healthcare provider via the communications network, said query comprising a query criteria; and
providing a query response including one or more healthcare providers satisfying the query criteria, said query response including only healthcare providers associated with at least one healthcare provider recommendation.

2. The method of claim 1, wherein:
said healthcare provider recommendations comprise only positive recommendations.

3. The method of claim 1, wherein:
said query criteria comprises a request for a healthcare provider recommendation related to a specified medical condition.

4. The method of claim 1, further comprising:
for each healthcare provider recommendation received via the network, receiving provider practice information.

5. The method of claim 4, further comprising:
reviewing the provider practice information for each healthcare provider recommendation.

6. The method of claim 4, wherein:
said provider practice information comprises one or more of the group consisting of: provider name, provider contact information, specialty, practice type, and hospital affiliation.

7. The method of claim 1, further comprising:
said receiving via the network the plurality of healthcare provider recommendations comprises receiving a textual testimonial for each of the plurality of healthcare provider recommendations.

8. The method of claim 7, wherein:
said query criteria comprises a query for a keyword in the textual testimonials of the plurality of healthcare provider recommendations.

9. The method of claim 1, wherein:
said storing the plurality of healthcare provider entries comprises storing the plurality of healthcare provider entries in a database, each of the healthcare provider entries in the database being associated with at least one healthcare provider recommendation.

10. The method of claim 9, wherein:
said healthcare provider entries in the database are accessible only by computer systems in a private intranet.

11. The method of claim 1, wherein:
said storing the plurality of healthcare provider entries comprises storing the plurality of healthcare provider entries in a database, each of the healthcare provider entries in the database being associated with at least one healthcare provider recommendation.

12. The method of claim 1, wherein:
said plurality of healthcare provider recommendations comprise a plurality of physician recommendations; and
said query for the healthcare provider comprises a query for a physician.

13. The method of claim 1, wherein:
said communications network comprises the Internet.

14. A method for providing information regarding healthcare providers over a communications network, comprising:
receiving via the communications network a plurality of healthcare provider recommendations, wherein for each healthcare provider recommendation received, receiving provider practice information;
storing a plurality of healthcare provider entries, each of the healthcare provider entries being associated with at least one healthcare provider recommendation; and
reviewing the provider practice information for each healthcare provider recommendation.

15. The method of claim 14, further comprising:
receiving a query for a healthcare provider via the communications network, said query comprising a query criteria; and
providing a query response including one or more healthcare providers satisfying the query criteria, said query response including only healthcare providers associated with at least one healthcare provider recommendation;

16. The method of claim 14, wherein:
said healthcare provider recommendations comprise only positive recommendations.

17. The method of claim 14, wherein:
said query criteria comprises a request for a healthcare provider recommendation related to a specified medical condition.

18. The method of claim 14, further comprising:
said provider practice information comprises one or more of the group consisting of: provider name, provider contact information, specialty, practice type, and hospital affiliation.

19. The method of claim 14, further comprising:
said receiving via the network the plurality of healthcare provider recommendations comprises receiving a textual testimonial for each of the plurality of healthcare provider recommendations.

20. The method of claim 19, wherein:
said query criteria comprises a query for a keyword in the textual testimonials of the plurality of healthcare provider recommendations.
